(19) United States
(12) Patent Application Publication
(10) Pub. No.: US 2010/0060458 A1
(43) Pub. Date: Mar. 11, 2010

(54) TRANSPONDER DEVICE

(75) Inventors: Scott Stole, Waconia, MN (US); Brian Bender, Victoria, MN (US); Glen Zirbes, Silver Lake, MN (US); Tom Holsapple, Silver Lake, MN (US)

Correspondence Address: SCHWEGMAN, LUNDBERG & WOESSNER, P.A., P.O. BOX 2938, MINNEAPOLIS, MN, 55402, US

(73) Assignee: Smartrac IP B.V., Amsterdam (NL)

(21) Appl. No.: 12/208,144

(22) Filed: Sep. 10, 2008

(51) Int. Cl. G08B 13/14

(52) U.S. Cl. 340/572.8

(57) ABSTRACT

The present disclosure generally pertains to a transponder device (10) comprising a transponder unit (37), which is arranged in a housing (13) and has an antenna device (38) and a chip (39), the housing forming a receiving space between a transparent front wall (15) and a housing rear wall (16) having arranged therein an optically readable information carrier (34), the housing rear wall having a fastening edge (22) defining a fastening plane (21) of the housing.

### TECHNICAL FIELD

The present disclosure pertains to a transponder device that can include a transponder unit, which can be arranged in a housing and can have an antenna device and a chip. In a particular example, the housing forms a receiving space between a transparent front wall and a housing rear wall having arranged therein an optically readable information carrier, the housing rear wall having a fastening edge defining a fastening plane of the housing.

### BACKGROUND

Transponder devices employed for identifying and locating objects are routinely mounted on the surface of the respective objects and are thus placed in an exposed position, in which position said objects are exposed to environmental conditions. The objects typically provided with transponder devices are primarily consumer goods located in less harsh environments, such as retail outlets. In contrast, the permanent and functionally reliable arrangement of transponder devices on objects located in a harsh environment frequently proves to be problematic. In this context, the field of logistics where for instance transponder devices are attached to containers or also to vehicles serving for the handling of containers can be taken as an example. The ambient conditions prevailing under these circumstances involve the risk that a transponder device located at the surface of an object may be readily destroyed by mechanical forces.

Accordingly there is the risk of a malfunctioning of the transponder device, for instance by destruction of the antenna device or the chip, and thus of having no access to the information stored on the chip.

### BRIEF DESCRIPTION OF DRAWINGS

An embodiment of the transponder device will be discussed on the basis of the drawings in the following, whereby:

FIG. 1 illustrates a perspective view of a transponder device;

FIG. 2 illustrates a longitudinal-sectional view of the transponder device shown in FIG. 1 along intersection lines II-II of FIG. 1;

FIG. 3 illustrates a bottom view of an information carrier inserted into the housing shown in FIG. 1;

FIG. 4 illustrates a sectional view of the transponder device shown in FIG. 1 along intersection lines IV-IV.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### Overview

An embodiment of the present invention includes a transponder device particularly suited for employment under harsh conditions.

According to an embodiment of the invention, the transponder device includes a transponder unit, which is arranged in a housing and has an antenna device and a chip, the housing forming a receiving space between a transparent front wall and a housing rear wall having arranged therein an optically readable information carrier, the housing rear wall having a fastening edge defining a fastening plane of the housing.

On the basis of the transponder device according to various embodiments of the invention, there is provided a transponder device allowing on the one hand shielding of the transponder device from environmental conditions, such as forces directly exerted on the transponder device, by means of an arrangement of the transponder unit within a protective housing. On the other hand, by virtue of the special design of the housing such that there is provided an optically readable information carrier being part of the transponder device, even upon a possibly occurring damaging or malfunction of the transponder device there is the option to get the stored information in a redundant manner and unambiguously allocated to the object by virtue of the fastening edge.

An example of the transponder device includes an optically readable information carrier being arranged within the receiving space of the housing and being transparently covered by a housing front wall such that another information carrier protected against external impacts is provided additionally to the transponder unit, which information carrier is independent of the function of the transponder unit and contains information being redundant or supplemented for instance in the form of a barcode.

In an embodiment the fastening edge exposes an adhesive for attachment to a fastening surface of the object. According to another embodiment the fastening edge includes through holes for an attachment to a fastening surface by bolt means, for example, screws or rivets.

In an optional embodiment of the transponder device, the transponder unit is arranged at the housing rear wall and the information carrier is arranged at the housing front wall. This allows for an arrangement of the transponder unit being reliable against external forces at a distance from the housing front wall being exposed to environmental conditions. Simultaneously, by virtue of the arrangement of the information carrier at the housing front wall, a good optical recognizability and readability respectively of the information carrier can be ensured.

In an example, the transponder unit is arranged on a rear side of the optically readable information carrier that faces the housing rear wall, and when the information carrier is located in an intermediary plane at a distance from the housing rear wall and the housing front wall. By this measure, it is in the first instance possible to employ the information carrier itself as supporting substrate for the transponder unit, the substrate being positioned by means of an arrangement at a distance from both the housing rear wall and the housing front wall in an area being especially protected against impacts.

In an example of providing the housing front wall and the housing rear wall with support devices facing one another, which may advantageously be formed as webs or ribs, offers a particularly advantageous option for implementing the arrangement of the information carrier in the intermediary plane.

In accordance with an embodiment of the transponder device, the housing is formed at least in two parts comprising a fastening part having the housing rear wall formed therein, and a cover part having the housing front wall formed therein. In this way, the arrangement of the information carrier within the housing is implemented by simply inserting the information carrier into a housing part and subsequently realizing a joint connection between the fastening part and the cover part.

In order to realize that the transponder unit and the information carrier respectively are held within the housing in a hermetically sealed manner, it is particularly advantageous to have the fastening part and the cover part sealingly connected to one other in a connection area.

One readily feasible embodiment to have a sealed connection is to have a press fitting between the fastening part and the cover part.

Depending on the materials used for the manufacture of the housing, it may prove advantageous to arrange a sealing device in the connection area.

Alternatively the connection between the fastening part and the cover part is formed by ultrasonic welding or gluing.

An embodiment of the transponder device, a locating device is arranged in the recess, the locating device working independently of the function of the transponder unit.

Under ambient conditions in a harsh environment there might be not only the risk of malfunctioning or destruction of the transponder unit but also the risk that the transponder device becomes detached from the object, thus misinformation regarding the position of the object may occur as a result of the detachment of a still functional transponder device from the object.

According to an embodiment there is the option to detect the positioning of the transponder unit disposed in a joint housing with the locating device in a redundant manner. In the event that the locating device is in a particularly simple embodiment for instance formed from a metal object, such as a metal ball, it is rendered feasible to detect the position of the transponder unit either via the signal emitted by the transponder unit, or otherwise via detection of the locating device being in this embodiment designed as a metal ball by means of a metal detector. When the positional coordinates detected redundantly are subsequently non-conforming or exceeding an admissible range of tolerance, it can be concluded that the transponder device has become detached from the object at least to the extent that a spatial separation of the locating device and the transponder unit has been the result.

Alternatively, it is also possible to have the recess formed at the housing for receiving the locating device designed in such a manner that the locating device, namely for instance the metal object, is captively held within the recess. Thus, the locating device remains attached at the transponder device even when the transponder device and the housing respectively have become detached from the object. Hence, it is also feasible to retrieve the transponder device independently of a functional transponder unit. A transponder device embodied in the aforesaid manner is of special importance in food production where devices employed in production processes may be equipped with transponder devices susceptible of getting into the food when becoming detached from the device. Transponder devices of the above specified type may by means of locating devices arranged at the housing still be reliably located and removed from the food even in the instance that the transponder unit is itself no longer functional.

In an embodiment of the invention, the locating device may be formed as an active device emitting a location signal, such that the retrieval and the verification respectively of the position of the transponder device can be performed devoid of an actively-driven detector device.

Alternatively, it is also possible to have the locating device designed as a passive locating device reflecting, for instance, a location signal emitted by the detector device, thus allowing that the locating device may itself be formed in a manner as simple as possible, for instance as a metal ball.

### DETAILED DESCRIPTION

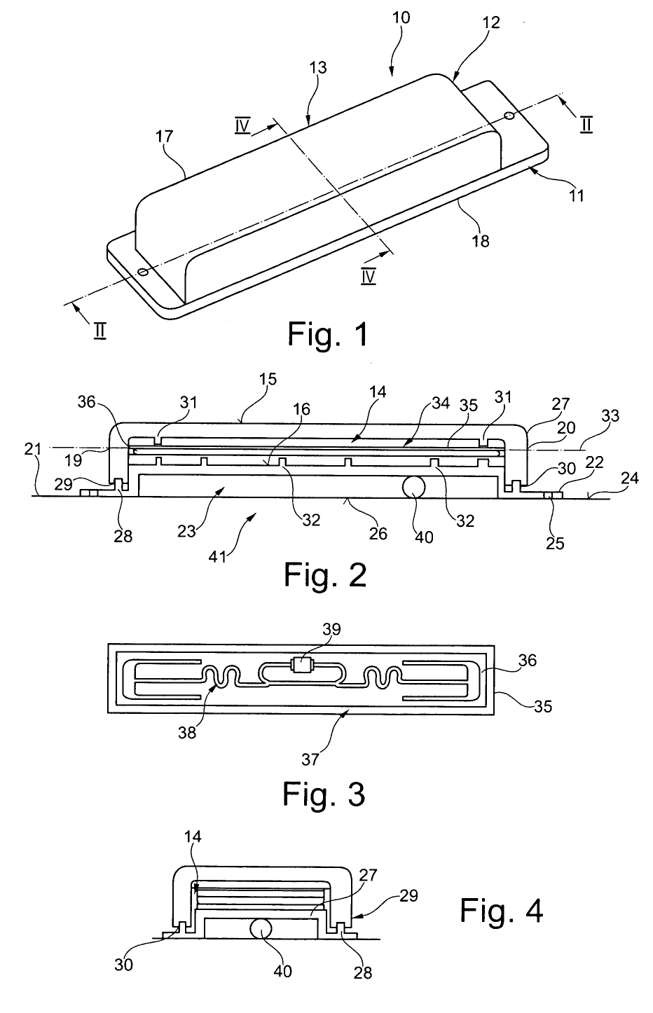

FIG. 1 illustrates a transponder device 10 including a housing 13 which is in this case formed of two parts, namely a fastening part 11 and a cover part 12.

As is clearly apparent from studying FIGS. 2 and 3 as an entirety, the housing 13 has a receiving space 14 defined at the top and at the bottom by a housing front wall 15 formed at the cover part 12 and by a housing rear wall 16 respectively formed at the fastening part 11. Along the peripheral side, the receiving space 14 is defined by longitudinal side walls 17, 18 and transversal side walls 19, 20 of the cover part 12.

The fastening part 11 having a recess 23 is formed thereon as a result of a recessed arrangement of the housing rear wall 15 relative to a fastening edge 22 formed in a fastening plane 21. The fastening part 11 serves for attachment of an object to be marked at a fastening surface 24. The attachment of the fastening part 11 at the fastening surface 24 may for instance be performed by means of fastening means, such as rivets or screws, being connected to the fastening surface 24 via fastening holes 25 provided in the fastening edge 22.

As is apparent from studying FIGS. 2 and 4, the recess 23 formed by the recessed arrangement of the housing rear wall 15 at the fastening part 11 on a fastening side 41 of the housing 13 is equipped with an opening 26 being formed in the fastening plane 21 and being covered by the latter when the fastening part 11 is arranged on the fastening surface 24.

An engagement web 28 engages into an engagement groove 30 being formed corresponding to the engagement web 28 in a frontal edge 29 of the cover part 12 for realizing a sealed connection between the fastening part 11 with the cover part 12 in order to create a joint connection. The engagement web 28 is formed circumferentially in relation to a pedestal-like elevated portion 27 formed by the housing rear wall 16 relative to the fastening edge 22.

As can be seen, particularly from FIG. 2, both the housing rear wall 16 and the housing front wall 15 are provided with support webs 31, 32 positioned on their inner sides that face the receiving space 14, the support webs being dimensioned so as to hold therebetween an information carrier 30 in its position in an intermediary plane 33 formed between the housing rear wall 16 and the housing front wall 15.

The information carrier 34 has a barcode provided on a carrier substrate 35, the barcode being in this context not specified in detail and readable at least through the housing front wall 15 transparently formed in the region of the barcode.

As illustrated in FIG. 3, the carrier substrate 35 of the information carrier 34 is provided with a transponder unit 37 being in this embodiment arranged on a foil carrier 36 and having a chip 39 being in contact with an antenna device 38.

Differing from the illustration shown in FIG. 3, the transponder unit 37 and the antenna device 38 respectively may also be directly attached onto the carrier substrate 35. Likewise differing from the illustration shown in FIG. 3, the antenna device may not only be formed of an electrically conductive material structure, but may instead for instance also be formed of a wire conductor.

FIGS. 2 and 4 illustrate the transponder device 10 in an arrangement attached on a fastening surface 24 having a locating device being in this embodiment formed as metal ball 40 held in a recess 23 covered by the fastening surface 24. When the fastening part 11 becomes detached from the fastening surface 24, the metal ball 40 is likely to get out of the recess 23 so that diverging positions between the transponder unit 37 and the metal ball 40 are detectable by means of a reading device interacting with the transponder unit 37 and a detector device interacting with the metal ball 40. This results in the conclusion that the transponder device 10 is no longer located at the object to be marked allowing that appropriate measures be taken to re-establish the spatial allocation of the transponder device and the object to be marked.

Impact-resistant plastics, such as polycarbonate, represent a suitable material to be used for the housing 13 of the transponder device. Moreover, basically any material, provided that the material does not impair the function of the transponder unit and the detection potential for the locating device held in the recess of the housing, may be used. In the event that, according to the previously specified exemplary embodiments, there is arranged an optically readable information carrier in the housing of the transponder unit, the housing front wall is at least in the region of the optically readable information carrier formed transparently.

1. A transponder device comprising:
a housing forming a receiving space between a transparent front wall and a housing rear wall, the housing including therein an optically readable information carrier, the housing rear wall having a fastening edge defining a fastening plane of the housing; and
a transponder unit arranged in the housing and including an antenna device and a chip.

2. The transponder device according to claim 1, wherein the fastening edge exposes an adhesive for attachment to a fastening surface.

3. The transponder device according to claim 1, wherein the fastening edge comprises through holes for an attachment to a fastening surface by a bolt.

4. The transponder device according to claim 1, wherein the information carrier is arranged at the housing front wall and the transponder unit is arranged at the housing rear wall, the housing rear wall being recessed relative to the fastening plane, thereby forming a recess opened towards the fastening plane.

5. The transponder device according to claim 4, wherein the transponder unit is arranged on a rear side of the optically readable information carrier that faces the housing rear wall, the information carrier being located in an intermediary plane at a distance from the housing rear wall and the housing front wall.

6. The transponder device according to claim 5, wherein for a defined arrangement of the information carrier in the intermediary plane the housing front wall and the housing rear wall are provided with support devices facing one another.

7. The transponder device according to claim 6, wherein the support devices are formed as webs.

8. The transponder device according to claim 6, wherein the housing is formed at least in two parts comprising a fastening part including the housing rear wall formed therein and a cover part including the housing front wall formed therein.

9. The transponder device according to claim 8, wherein the fastening part and the cover part are sealingly connected to one another in a connection area.

10. The transponder device according to claim 9, wherein the connection between the fastening part and the cover part is formed by a press-fitting.

11. The transponder device according to claim 10, wherein a sealing device is arranged in the connection area.

12. The transponder device according to claim 9, wherein the connection between the fastening part and the cover part is formed by ultrasonic welding.

13. The transponder device according to claim 9, wherein the connection between the fastening part and the cover part is formed by gluing.

14. The transponder device according to claim 13, comprising a locating device arranged in the recess, the locating device being independent of the function of the transponder unit.

15. The transponder device according to claim 14, wherein the locating device is formed as an active device emitting a location signal.

16. The transponder device according to claim 14, wherein the locating device is formed as a passive device reflecting a location signal.

17. The transponder device according to claim 1, wherein the housing is formed at least in two parts comprising a fastening part including the housing rear wall formed therein and a cover part including the housing front wall formed therein.

18. The transponder device according to claim 17, wherein the fastening part and the cover part are sealingly connected to one another in a connection area.

19. The transponder device according to claim 18, wherein the connection between the fastening part and the cover part is formed by a press-fitting.

20. The transponder device according to claim 19, wherein a sealing device is arranged in the connection area.

21. The transponder device according to claim 17, comprising a locating device arranged in the recess, the locating device being independent of the function of the transponder unit.

22. The transponder device according to claim 1, comprising a locating device arranged in the recess, the locating device being independent of the function of the transponder unit.
